(19) United States
(12) Patent Application Publication
(10) Pub. No.: US 2022/0354270 A1
(43) Pub. Date: Nov. 10, 2022

(54) AN INFANT TRANSPORTATION SYSTEM

(71) Applicant: DYMLA AB, Lidingö (SE)

(72) Inventors: Karin Anna Cecilia Dymmel, Lidingö (SE); Per David Dymmel, Lidingö (SE)

(73) Assignee: DYMLA AB, Lidingö (SE)

(21) Appl. No.: 17/754,297

(22) PCT Filed: Sep. 29, 2020
(86) PCT No.: PCT/EP2020/077256

§ 371 Date: Mar. 29, 2022

(30) Foreign Application Priority Data
Sep. 30, 2019 (SE) 1951111-2

(51) Int. Cl. A47D 13/02

(52) U.S. Cl. CPC A47D 13/02

(57) ABSTRACT

An infant transportation system comprising: an infant enclosure for accommodating an infant; a filter; a mesh; a fan that is configured to pressurise the inside of the infant enclosure such that air is drawn into the infant enclosure through the filter, and air exits the infant enclosure through the mesh; and one or more sensors configured to provide sensed-data that is a measure of one or more environmental parameters associated with the infant transportation system. The infant transportation system may also include a location determining device configured to determine location-data that represents a location associated with the infant transportation system at the time that the sensed-data was provided; and a transmitter configured to transmit the sensed-data and the associated location-data to a third party device.

### CROSS-REFERENCE TO RELATED APPLICATIONS

This is a National Stage Application, filed under 35 U.S.C. § 371, of International Patent Application No. PCT/EP2020/077256, filed on Sep. 29, 2020, which claims priority to Swedish Patent Application No. 1951111-2, filed on Sep. 30, 2019, the disclosures of which are incorporated herein by reference in their entireties.

### TECHNICAL FIELD

The present disclosure relates to infant transportation systems, and in particular to infant transportation systems that can provide clean air to an infant enclosure that accommodates the infant.

### BACKGROUND

In cities and other heavily polluted areas it can be undesirable to transport a child in the open air due to the negative effects on the child's health from breathing in polluted air.

### SUMMARY

According to a first aspect of the present disclosure there is provided an infant transportation system comprising:

an infant enclosure for accommodating an infant;

a filter;

a mesh;

a fan that is configured to pressurise an inside of the infant enclosure such that air is drawn into the infant enclosure through the filter, and air exits the infant enclosure through the mesh;

one or more sensors configured to provide sensed-data that is a measure of one or more environmental parameters associated with the infant transportation system.

The filter may form part of a wall of the infant enclosure. The mesh may form part of a wall of the infant enclosure.

The infant transportation system may further comprise:

a location determining device configured to determine location-data that represents a location associated with the infant transportation system at a time that the sensed-data was provided.

The infant transportation system may further comprise:

a transmitter configured to transmit the sensed-data, and optionally the associated location-data, to a third party device.

The infant transportation system may further comprise the third party device, which is configured to:

receive sensed-data and location-data from a plurality of transmitters associated with a respective plurality of infant transportation systems; and

process the sensed-data and the location-data in order to generate a map that graphically illustrates values of the sensed-data at locations on the map that correspond to the associated location-data.

The infant transportation system may further comprise a time-recorder that is configured to determine time-data that represents the time at which the sensed-data was provided. The transmitter may be configured to also transmit the time-data along with the sensed-data and the location-data to the third party device.

The infant transportation system may further comprise the third party device, which is configured to:

receive sensed-data, location-data and time-data from a plurality of transmitters associated with a respective plurality of infant transportation systems; and

process the sensed-data, the location-data and the time-data in order to generate a map that graphically illustrates the values of the sensed-data at locations on the map that correspond to the associated location-data for a particular period of time in a day.

The infant transportation system may further comprise a mobile communications device, wherein:

the mobile communications device comprises the location determining device and the transmitter;

the one or more sensors are associated with the infant enclosure; and

the mobile communications device is in electronic communication with the one or more sensors such that it is configured to receive the sensed-data from the one or more sensors.

The one or more sensors may comprise one or more of:

an air pollution sensor that is configured to provide sensed-external-pollution-data that is representative of a level of air pollution outside of the infant enclosure;

an air pollution sensor that is configured to provide sensed-internal-pollution-data that is representative of a level of air pollution inside the infant enclosure;

a temperature sensor that is configured to provide sensed-internal-temperature-data that is representative of an air temperature inside the infant enclosure;

a humidity sensor that is configured to provide sensed-internal-humidity-data that is representative of a humidity inside the infant enclosure;

a motion sensor that is configured to provide sensed-motion-data that is representative of movement inside the infant enclosure;

a noise-pollution sensor that is configured to provide sensed-sound-data that is representative of sound levels one or both of inside and outside the infant enclosure;

a particle sensor that is configured to provide sensed-external-particle-data that is representative of a level of one or more types of particle outside of the infant enclosure;

a particle sensor that is configured to provide sensed-internal-particle-data that is representative of a level of one or more types of particle inside the infant enclosure; and

a microbe sensor that is configured to provide sensed-microbe-data that is representative of bacteria, viruses or fungi.

The air pollution sensor may comprise one or more of an ozone sensor, a particulate matter sensor, a carbon monoxide or carbon dioxide sensor, a sulphur dioxide sensor, a ground-level ozone sensor, an NOx (nitrogen monoxide and nitrogen dioxide) sensor, a total volatile organic compounds (TVOC) sensor, a peroxyacetyl nitrate sensor, a free radicals sensor and a nitrous oxide sensor. The particulate matter sensor and/or the particle sensor may be configured to detect one or more types of particulates/particles including, but not limited to, pollen, dust, nano-particles and building debris.

The infant enclosure may comprise one or more camera devices configured to record still imagery, successive-still imagery or video imagery. The camera devices may be arranged to record areas outside of the infant enclosure, such as to record imagery of the environment or passers-by. Imagery of the environment or passers-by may be used to identify one or more of the location of the infant enclosure, the orientation of the infant enclosure or persons or animals approaching the infant enclosure.

In some embodiments, the camera may be configured to provide imagery to a processor coupled to a memory for the determination of features of the imagery, such as for object recognition, facial recognition or any other suitable feature recognition techniques.

One or more camera devices may be arranged to record the interior of the infant enclosure. Imagery of the interior of the infant enclosure may be used to detect the presence or non-presence of an infant. Any one or a combination of imagery of the infant, sensed-sound-data and sensed-motion-data may be used to determine a sleeping state of the infant. The sleeping state of the infant may be a measure of the degree of rest of the infant, such as whether the infant is asleep or awake, how deeply the infant is sleeping and, in some examples, if the infant has recently awoken or fallen asleep. For example, a determination that the baby has recently woken may result in a notification being sent to a remote device in order to alert a parent. Sleeping state data of the infant may be recorded in order to allow for analysis of the conditions in which the infant sleeps most soundly. Control of the fan may be based on the conditions in which the infant sleeps most soundly. For example, if the infant is asleep and sleeping state data has identified that the infant sleeps better in cooler conditions, the fan may operate at an increased rate. Alternatively, the infant may sleep better when the fan is quieter, and so the power level of the fan may be reduced when the infant is sleeping, or when sleeping state data indicates that the infant is only lightly sleeping, i.e., liable to awaken.

As a further example, the processor may: process imagery, sensed-sound-data and/or sensed-motion-data to determine whether or not an infant is inside the infant enclosure; and automatically control the fan based on whether or not the infant is inside the infant enclosure. For instance, the controller may automatically disable the fan when the infant is not inside the infant enclosure in order to extend battery life.

In yet other examples, the imagery may be used to identify potential hazards within the infant enclosure. Examples hazards may include the presence of a cloth, cover or clothing covering the infant's face, the removal or disruption of an infant's blanket or the undesired twisting of the infant in the infant enclosure.

The fan may be a radial fan.

The infant enclosure may comprise:

a carrycot having a flat lower surface on which an infant can lie down;

a hood; and

a removable cover that is attachable to the carrycot and the hood, such that the carrycot, the hood and the removable cover define a fully enclosed volume for accommodating the infant.

The filter may form part of a wall of the hood. The mesh may form part of the removable cover.

The removable cover may include the mesh and a solid portion. When the removable cover is not attached to the carrycot and the hood, an opening may be defined through which an infant can be passed to enter or leave the infant enclosure. The opening may have a first portion and a second portion. The first portion of the opening may be defined by: (i) a part of a peripheral edge of the hood that extends beyond a top of the carrycot; and (ii) a line that joins two points at which the hood overlaps the carrycot. The second portion of the opening may be defined by: (i) the line that joins the two points at which the hood overlaps the carrycot; and (ii) an edge of side walls of the carrycot that are distal from the hood. The removable cover may be connectable to the carrycot and the hood such that: the mesh closes off the first portion of the opening, and the solid portion closes off the second portion of the opening. This may provide for protection against the ingress of parasites, mosquitos or other undesirable creatures into the infant transportation system.

The infant transportation system may further comprise a filter unit which includes the filter and the fan. The filter unit may be attached to the hood.

The filter may be located upstream or downstream of an airflow direction through the fan.

The mesh may have a first surface that faces into the infant enclosure, and a second surface that faces away from the infant enclosure. The fan and the mesh may be located relative to each other such that, across substantially the entire mesh, an air pressure on the first surface of the mesh is greater than an air pressure on the second surface when the fan is in use.

The fan may be configured to provide an airflow into the infant enclosure. The airflow may be directed towards the mesh. The airflow may be directed to an upper region of the mesh when the infant transportation system is in an in-use orientation. A porous sheet, such as a filter media, may be located between the fan and the infant enclosure. The porous sheet can provide for increased homogeneity of the airflow into the infant enclosure. The porous sheet may comprise a foam sheet. The porous sheet may be arranged before or after the filter or the mesh. The porous sheet may also provide additional protection from certain types of pollution entering the infant enclosure. In some examples, the porous sheet may have a layer of carbon thereon. The layer of carbon may be configured to reduce the flow of at least ozone, carbon monoxide, carbon dioxide, sulphur dioxide into the infant enclosure.

The hood may be foldable.

The infant enclosure may further comprise a handle that is holdable by a person at a location that corresponds to a longitudinal centre of mass of the infant enclosure. The handle may be connected to the hood. The handle may extend in a longitudinal direction of the infant enclosure. This may provide a weighted equilibrium to the infant enclosure such that only a single handle is required to lift the infant enclosure while maintaining the lower surface of the infant enclosure as substantially horizontal.

One end of the handle may be connected to an upper front edge region of the hood. The other end of the handle may be connected to a position on the hood that is spaced apart from the upper front edge region in a longitudinal direction.

The handle may be connected to a laterally central region of the hood.

The infant transportation system may further comprise a wheeled frame on which the infant enclosure can be mounted.

The infant transportation system may further comprise a display that is configured to provide a graphical representation of the sensed-data.

The infant transportation system may further comprise a controller configured to:

process the sensed-data and determine a fan-control-signal for automatically setting an adjustable parameter of the fan; and

provide the fan-control-signal to the fan.

The adjustable parameter of the fan may be fan speed.

There may be provided a computer program, which when run on a computer, causes the computer to configure any apparatus, including a controller disclosed herein or perform any method disclosed herein. The computer program may be a software implementation, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

The computer program may be provided on a computer readable medium, which may be a physical computer readable medium such as a disc or a memory device, or may be embodied as a transient signal. Such a transient signal may be a network download, including an internet download.

### BRIEF DESCRIPTION OF THE DRAWINGS

One or more embodiments will now be described by way of example only with reference to the accompanying drawings in which:

FIG. 1a shows a perspective view from the front of an example embodiment of an infant transportation system;

FIG. 1b shows a perspective view from the back of the infant transportation system of FIG. 1a;

FIG. 1c shows the removable cover separately from the other components of the infant enclosure;

FIG. 1d shows the carrycot and the hood separately from the removable cover;

FIG. 2 shows an example of a network that includes a plurality of infant enclosures;

FIG. 3 shows a view of the inside of a hood that can be used with any of the infant transportation systems disclosed herein;

FIG. 4 shows a perspective view from the back of the infant transportation system of FIG. 1a, with the filter unit partially disassembled;

FIG. 5 shows a top view of an example embodiment of an infant enclosure; and

FIG. 6 shows a side view of an example embodiment of an infant enclosure.

### DETAILED DESCRIPTION

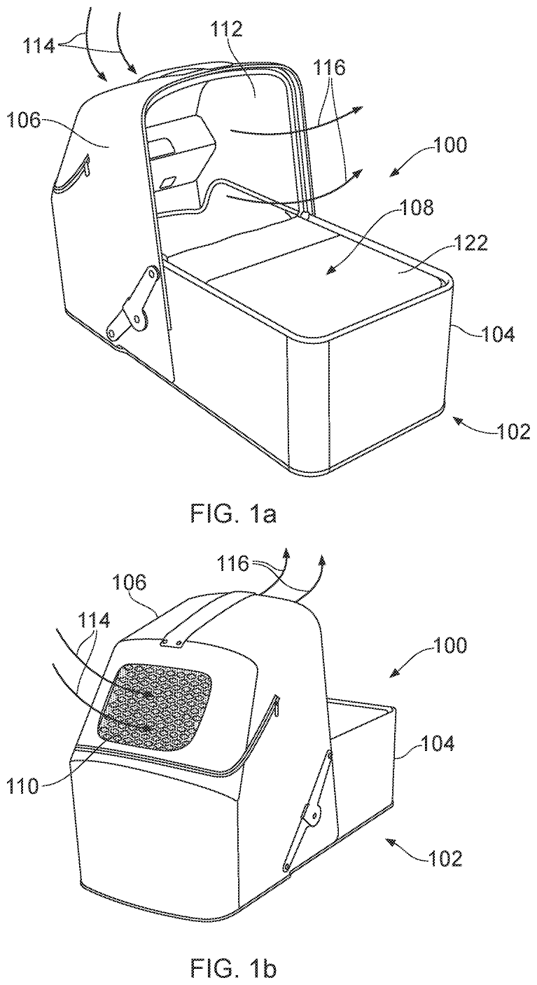

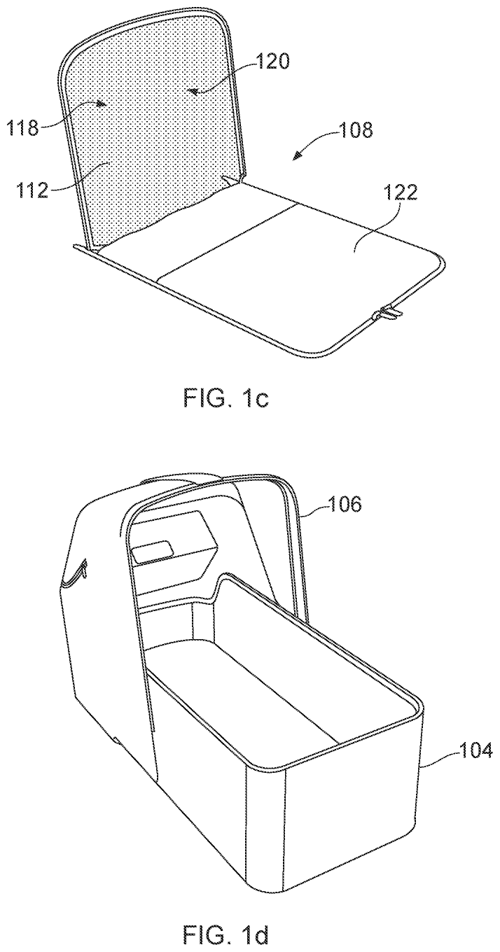

FIG. 1a shows a perspective view from the front of an example embodiment of an infant transportation system 100. FIG. 1b shows a perspective view from the back of the same infant transportation system 100.

The infant transportation system 100 includes an infant enclosure 102 for accommodating an infant. In this example the infant 102 enclosure includes a carrycot 104; a hood 106, and a removable cover 108. The carrycot 104 has a flat lower surface on which an infant can lie down, and side walls that extend away from the edges of the flat lower surface, in this example around the entire peripheral edge of the flat lower surface. In this way, the carrycot 104 is open at its upper end so that an infant can be placed into, or removed from, the carrycot 104.

FIG. 1c shows the removable cover 108 separately from the other components of the infant enclosure. FIG. 1d shows the carrycot 104 and the hood 106 separately from the removable cover 108. In this example, the hood 106 is foldable.

FIG. 1a shows the carrycot 104, the hood 106 and the removable cover 108 all connected together such that they define a fully enclosed volume for accommodating the infant. That is, there are no significant gaps between the carrycot 104, the hood 106 and the removable cover 108 when they are connected together such that there will be no significant airflow through any gaps between the separate components. In this example, the removable cover 108 is releasably attachable to the carrycot 104 and the hood 106 using a zip, although it will be appreciated that any other fastening means could be used, such as Velcro™ or magnets.

The infant enclosure 102 includes a filter 110 and a mesh 112. The mesh 112 may form part of a wall of the infant enclosure 102, and in this example the mesh 112 forms part of a wall of the removable cover 108. The filter 110 may also form part of a wall of the infant enclosure 102. Optionally, as will be described below, the filter 110 may be provided as part of a filter unit, and the filter unit may form part of a wall of the infant enclosure. In this example the filter 110 forms part of a wall of the hood 106. Similarly, it will be appreciated that a filter unit may form part of a wall of the hood 106. It will be appreciated that the filter 110 and the mesh 112 may be located in different walls of the infant enclosure 102 in other embodiments. Both the mesh 112 and the filter 110 are permeable such that air can flow through them.

The infant transportation system 100 also includes a fan (not shown in FIGS, 1a-1d, although it will be discussed in detail below) that can pressurise the inside of the infant enclosure 102 such that air is drawn into the infant enclosure 102 through the filter 110, and air exits the infant enclosure 102 through the mesh 112. The filter 110 may be located upstream or downstream of an airflow direction through the fan. Such airflow into the infant enclosure 102, through the filter 110, is shown schematically in FIGS, 1aand lb with arrows 114. The airflow out of the infant enclosure 102, through the mesh 112, is shown schematically in FIGS. 1aand 1b with arrows 116. A porous sheet (not shown), such as a filter media, may be located between the fan and the infant enclosure 102. The porous sheet can provide for increased homogeneity of the airflow into the infant enclosure. The porous sheet may comprise a foam sheet, such as a PPI pad. The porous sheet may be arranged before or after, in an airflow direction, the filter 110 or the mesh 112. The porous sheet may also provide additional protection from certain types of pollution entering the infant enclosure.

Use of such a filter 110 and fan can enable the air inside the infant enclosure 102, and therefore the air that is being breathed in by the infant, to be sufficiently clean and healthy. The filter 110 can take any form that is known in the art to remove any undesirable particles or gasses from air that is outside the infant enclosure 102. The undesirable particles may be one or more of air pollution, carbon monoxide, carbon dioxide, nitrogen oxides (NOx) viruses and bacteria, as non-limiting examples. For instance, the filter 110 may be an advanced carbon-depleted HEPA air filter or an advanced carbon-depleting-E1 filter. The carbon-depletcing-E11 filter may comprise activated carbon filtrates.

With particular reference to FIG. 1c, the mesh 112 has a first surface 118 that faces into the infant enclosure, and a second surface 120 that faces away from the infant enclosure. The first surface 118 can be considered as defining part of an inner surface of the infant enclosure, and the second surface 120 can be considered as defining part of an outer surface of the infant enclosure. The fan (not shown) and the mesh 112 can be located relative to each other such that, across substantially the entire mesh, the air pressure on the first surface of the mesh is greater than the air pressure on the second surface when the fan is in use. This can increase the likelihood that no dirty air will enter the infant enclosure through the mesh 112.

The fan can provide an airflow into the infant enclosure, and the airflow can be directed towards the mesh 112. In some examples, the fan can be orientated with respect to the mesh 112 such that it provides an even distribution of air along the mesh 112, which in turn can also create an even flow of air through the infant enclosure 102. In addition to providing a positive air pressure in the infant enclosure 102, the fan can also provide an air flow which prevents or minimises outside air entering the infant enclosure 102 through the mesh 112 when the fan is on. In one example, the air flow from the fan can be directed at an upper region of the mesh 112 when the infant transportation system is in an in-use orientation. Due to the aerodynamics of the mesh 112, the air will spread evenly along the inside surface of the mesh 112 such that it exits the infant enclosure 102 through substantially the entire surface of the mesh 112. By doing so the air creates a flow from inside to outside, evenly at the surface of the mesh 112, and prevents or reduces air from entering into the infant enclosure 102 through the mesh 112.

In some examples, the mesh 112 can be a UV-mesh such that it also provides protection from ultra-violet light for an infant inside the infant enclosure 102.

The removable cover 108 also includes a solid portion 122, which is substantially impermeable such that air cannot pass through it (in contrast to the mesh 112, which is permeable to air). In this example, the solid portion 122 is generally parallel with a base of the carrycot 104 when it is attached to the carrycot 104. This can provide good protection from the environment for an infant in the infant enclosure 102. Also, providing the solid portion 122 in this location can assist with controlling the airflow in the infant enclosure 102 such that external air only enters the infant enclosure 102 through the filter 110. It will be appreciated that if air were allowed to enter the infant enclosure 102 through a different opening then this could degrade the air quality inside the infant enclosure. As shown in the figures, the solid portion 122 is releasably attachable to the carrycot 104, and in the example shown is not releasably attachable to the hood 106.

As shown in FIGS, 1aand 1c, the mesh 112 of the removable cover 108 extends in a plane that is transverse to the base of the carrycot 104. The mesh 112 is releasably attachable to the hood 106, and in the example shown is not releasably attachable to the carrycot 104. Providing the mesh 112 in this orientation can assist with achieving the desired airflow in the infant enclosure 102. Also, the location of the mesh 112 enables it to have only limited exposure to rain. Also, the mesh 112 can conveniently be at least semi-transparent so that a parent or guardian can observe the infant in the infant enclosure 102 to ensure that they are ok.

As shown in FIG. 1d, when the removable cover 108 is not attached to the carrycot 104 and the hood 106, an opening is defined through which an infant can be passed to enter or leave the infant enclosure 102. The opening can be considered as having a first portion and a second portion. The first portion of the opening is defined by: (i) the part of the peripheral edge of the hood 106 that extends beyond the top of the carrycot 104; and (ii) a line that joins the two points at which the hood 106 overlaps the carrycot 104. The second portion of the opening is defined by: (i) the line that joins the two points at which the hood 106 overlaps the carrycot 104; and (ii) the edge of the side walls of the carrycot 104 that are distal from the hood 106. When the removable cover 108 is connected to the carrycot 104 and the hood 106, the mesh 112 closes off the first portion of the opening, and the solid portion 122 closes off the second portion of the opening.

The infant transportation system in this example also includes one or more sensors (not shown). The sensors can provide sensed-data that is a measure of one or more environmental parameters associated with the infant transportation system. The sensors can be located inside the infant enclosure 102, or outside the infant enclosure 102.

The sensors can include one or more of the following:

an air pollution sensor that provides sensed-external-pollution-data, which is representative of the level of air pollution outside of the infant enclosure;

an air pollution sensor that provides sensed-internal-pollution-data, which is representative of the level of air pollution inside the infant enclosure;

a temperature sensor that provides sensed-internal-temperature-data, which is representative of the air temperature inside the infant enclosure;

a temperature sensor that provides sensed-external-temperature-data, which is representative of the air temperature outside the infant enclosure;

a humidity sensor that provides sensed-internal-humidity-data, which is representative of the humidity inside the infant enclosure;

a humidity sensor that provides sensed-external-humidity-data, which is representative of the humidity outside the infant enclosure;

a motion sensor that is configured to provide sensed-motion-data that is representative of movement inside the infant enclosure;

a noise-pollution sensor that is configured to provide sensed-sound-data that is representative of sound levels one or both of inside and outside the infant enclosure. The noise-pollution sensor may be a microphone;

a particle sensor that is configured to provide sensed-external-particle-data that is representative of the level of one or more types of particle outside of the infant enclosure;

a particle sensor that is configured to provide sensed-internal-particle-data that is representative of the level of one or more types of particle inside the infant enclosure; and

a microbe sensor that is configured to provide sensed-microbe-data that is representative of bacteria, viruses or fungi.

Such an air pollution sensor may include one or more of an ozone sensor, a particulate matter sensor, a carbon monoxide sensor, a carbon dioxide sensor, a sulphur dioxide sensor, a ground-level ozone sensor, an NOx (nitrogen monoxide and nitrogen dioxide) sensor, a total volatile organic compounds (TVOC) sensor, a peroxyacetyl nitrate sensor, a free radicals sensor and a nitrous oxide sensor. The particulate matter sensor and/or the particle may be configured to detect one or more types of particulates/particles including, but not limited to, pollen, dust, nanoparticles and building debris.

The infant enclosure may comprise one or more camera devices configured to record still imagery, successive-still imagery or video imagery. The camera devices may be arranged to record areas outside of the infant enclosure, such as to record imagery of the environment or passers-by. Imagery of the environment or passers-by may be used to identify one or more of the location of the infant enclosure, the orientation of the infant enclosure or persons or animals approaching the infant enclosure.

In some embodiments, the camera may be configured to provide imagery to a processor coupled to a memory for the determination of features of the imagery, such as for object recognition, facial recognition or any other suitable feature recognition techniques.

One or more camera devices may be arranged to record the interior of the infant enclosure. Imagery of the interior of the infant enclosure and optionally other types of sensed-data described herein, may be used to detect the presence or non-presence of an infant. Any one or a combination of imagery of the infant, sensed-sound-data and sensed-motion-data may be used to determine a sleeping state of the infant. The sleeping state of the infant may be a measure of the degree of rest of the infant, such as whether the infant is asleep or awake, how deeply the infant is sleeping and, in some examples, if the infant has recently awoken or fallen asleep. For example, a determination that the baby has recently woken may result in a notification being sent to a remote device in order to alert a parent. Sleeping state data of the infant may be recorded in order to allow for analysis of the conditions in which the infant sleeps most soundly. Control of the fan may be based on the conditions in which the infant sleeps most soundly. For example, if the infant is asleep and sleeping state data has identified that the infant sleeps better in cooler conditions, the fan may operate at an increased rate. Alternatively, the infant may sleep better when the fan is quieter, and so the power level of the fan may be reduced when the infant is sleeping, or when sleeping state data indicates that the infant is only lightly sleeping, i.e., liable to awaken.

In yet other examples, the imagery may be used to identify potential hazards within the infant enclosure. Examples hazards may include the presence of a cloth, cover or clothing covering the infant's face, the removal or disruption of an infant's blanket or the undesired twisting of the infant in the infant enclosure.

In some examples, the infant transportation system 100 can include a display (not shown) that provides a graphical representation of the sensed-data. The display may be local to the infant enclosure 102, for example it may be mounted on an outer surface of the infant enclosure 102. Alternatively or additionally, a remote device such as a mobile communications device may provide the functionality of the display. As non-limiting examples, the display may illustrate graphically one or more of the following: (a) instantaneous values of one or more types of sensed-data, (b) a plot of multiple values for the same type of sensed-data over time, (c) a time-averaged value for one or more of the sensed-data, for instance a mean value of the sensed-data over the last 10 seconds.

In one example, the display can provide a graphical representation of the sensed-external-pollution-data and/or the sensed-internal-pollution-data in order to visualise the air quality both inside and outside the infant enclosure.

Optionally the infant transportation system may include a controller (not shown), which may be co-located with the infant enclosure or remote from it. Again, for example, the functionality of the controller may be provided by a mobile communications device. The controller may process the sensed-data and determine a fan-control-signal for automatically setting an adjustable parameter of the fan. The adjustable parameter of the fan may be fan speed, for example. The controller can then provide the fan-control-signal to the fan in order to automatically control its operation based on the sensed-data. In some applications, this can enable the fan to be used in a power-efficient way such that it is not operating at an unnecessarily high speed when it is not required to achieve acceptable air quality in the infant enclosure 102. This can be especially useful when the fan is battery operated.

Depending upon the type of filter 110 being used, the controller may provide a fan-control-signal that causes the fan speed to be increased or decreased when the sensed-data indicates that the pollution levels in the infant enclosure 102 are too high. For instance, the controller may compare sensed-internal-pollution-data with one or more threshold values to determine the fan-control-signal, and hence how the fan will be automatically controlled.

In some applications, the controller may compare sensed-internal-temperature-data with one or more threshold values to determine the fan-control-signal, and hence how the fan will be automatically controlled. For instance, this can be used to increase the fan speed if the internal temperature is too high in an attempt to cool an infant in the infant enclosure 102.

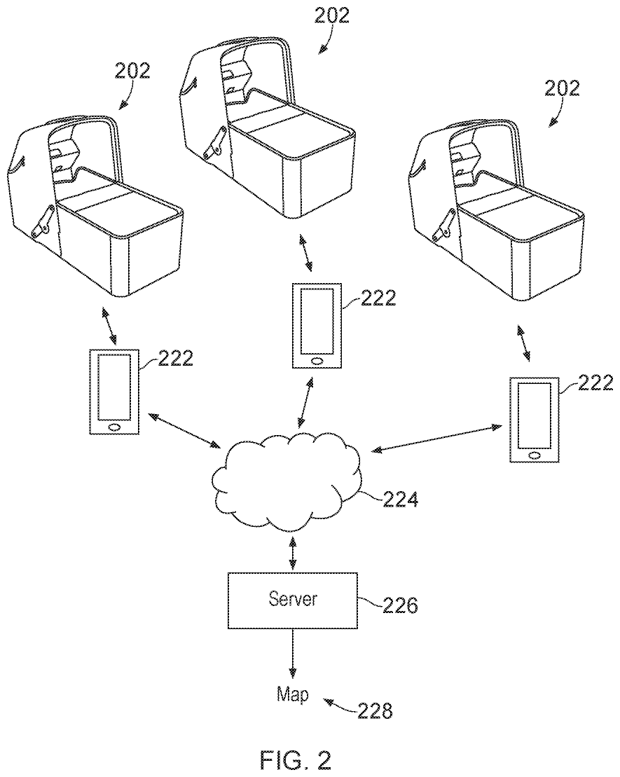

The infant transportation system 100 can also include a location determining device (not shown), such as a Global Positioning System or any other known system. In some examples, the location determining device may be directly connected to the infant enclosure 102. In other examples, the location determining device may be provided by a different device, for example a mobile communications device such as a smartphone, that is in the vicinity of the infant enclosure. Further details of such an example will be described below with reference to FIG. 2.

The location determining device can determine location-data that represents a location associated with the infant transportation system. This may be a precise location of the infant enclosure if the location determining device is directly attached to the infant enclosure, or may be an approximate of the infant enclosure if the location determining device is known to be in the vicinity of the infant enclosure. For instance, if the location determining device is provided by a smartphone that is connected to a component of the infant enclosure using Bluetooth™.

In examples, where the infant transportation system includes both a location determining device and one or more sensors, the location determining device may determine location-data that represents a location associated with the infant transportation system at the time that the sensed-data was provided. The infant transportation system can also include a transmitter for transmitting the sensed-data and the associated location-data to a third-party device. As above, the functionality of the transmitter may be provided by an associated mobile communications device, or by a bespoke transmitter that is associated with the infant transportation system. Further details of such an example are provided below with reference to FIG. 2.

In some examples, the infant transportation system can be a hand-held carrier. Optionally, the infant transportation system can include a wheeled frame on which the infant enclosure is mounted, such that the infant transportation system can be operated as a buggy or a pram.

FIG. 2 shows an example of a network that includes a plurality of infant enclosures 202, each of which is in electronic communication with a mobile communications device 222. More particularly, in some examples, one or more sensors that are local to the infant enclosure 202 may be in electronic communication with a mobile communications device 222. The mobile communications device 222 may be a smartphone, for instance, and may be able to communicate with an associated infant enclosure 202/sensors using Bluetooth™ or any other wired or wireless communications protocol. FIG. 2 also shows a server 226, which is an example of the third-party device that is described above. It will be appreciated that the functionality of the server 226 can be provided in any way that is known in the art, including using cloud computing, a single processor or distributed processing.

In this example the transmitter for transmitting data to the server 226 is associated with the mobile communications device 222, and this transmission of data is illustrated graphically in FIG. 2 as passing through a network 224. The network 224 may be the internet or any other telecommunications network using any appropriate communications protocol. It will be appreciated that in other examples the infant enclosures 202 could have local transmitters that are suitable for communicating directly with the server 226, without the need for a mobile communications device 222.

With reference to various ones of the components of the infant transportation system that are described above with reference to FIG. 1:

one or more of the sensors may be associated with either or both of the infant enclosure 202 and the mobile communications device 222; and

the location determining device may be associated with either or both of the infant enclosure 202 and the mobile communications device 222.

As shown in FIG. 2, the server 226 can receive data from a plurality of transmitters associated with a respective plurality of infant transportation systems.

In this example, the server 226 receives sensed-data and location-data from a plurality of transmitters associated with a respective plurality of infant transportation systems. The server 226 can process the sensed-data and the location-data in order to generate a map that graphically illustrates the values of the sensed-data at locations on the map that correspond to the associated location-data. In this way, especially when the sensed-data includes sensed-external-pollution-data, the map 228 can illustrate areas of a town or city (in particular) that have high pollution levels. Such a map 228 can be useful for anyone who wishes to move around the town or city to plan their route to avoid highly polluted areas. This information can be especially useful to other people who wish to walk with their infant transportation systems, or walkers, runners, cyclists, etc.

In some examples, either or both of the infant enclosures 202 and the mobile communications devices 222 can include a time-recorder that determines time-data, which represents the time at which the sensed-data was provided. In which case, the transmitters can transmit the time-data along with the sensed-data and the location-data to the server 226. In these examples, the server 226 can receive sensed-data, location-data and time-data from the plurality of transmitters; and process the sensed-data, the location-data and the time-data in order to generate a map that graphically illustrates the values of the sensed-data at locations on the map that correspond to the associated location-data for a particular period of time in a day. In this way, maps can be generated for the same location but at different times. Optionally, the maps can be generated using historic data that was recorded at the same time of day, but on different days.

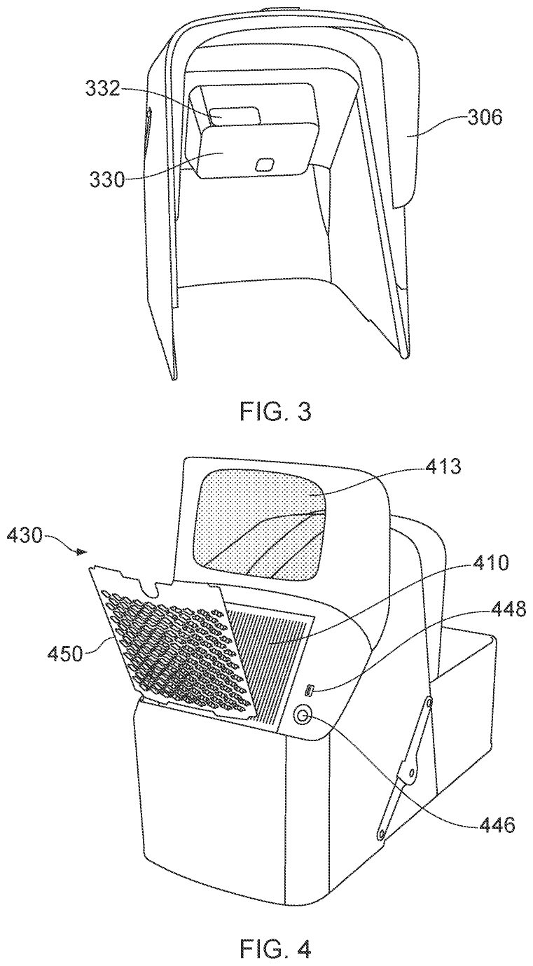

FIG. 3 shows a view of the inside of a hood 306 that can be used with any of the infant transportation systems disclosed herein. Attached to an inside surface of the hood 306 is a filter unit 330 which includes a filter and fan. The fan may be a radial fan. The filter unit 330 may have one or more openings 332 on side surfaces of the filter unit 330 such that an air flow from the fan enters the infant enclosure in a direction that is parallel to the surface of the hood 306 on which the filter unit 330 is attached. As shown in FIG. 3, the opening 332 in the filter unit 330 is located such that the fan provides an airflow through the opening 332 in a direction that is towards the mesh when the hood 306 is in a raised position.

FIG. 4 shows a perspective view from the back of the infant transportation system 400 of FIG. 1a, with the filter unit 430 partially disassembled showing a filter-mesh 413, a plastic cover 450 and the filter 410. It will be appreciated that the plastic cover 450, filter 410 and fan (not shown) may be arranged in a different order. It will also be appreciated that one or more, or all, of these components can be considered as forming part of a wall of the infant enclosure because they can provide part of a barrier between the inside of the infant enclosure and the outside of the infant enclosure.

An indicator 446 is provided which may provide one or more of a binary power indicator, a power level indicator or a charging state indicator. A power provision port 448 is rovided which is configured to be connected to a power supply for the provision of direct-powering of the infant transportation system or for charging of a battery associated with the electronics of the infant transportation system. The power provision port 448 may comprise any suitable power provision port, such as a USB Type-A, USB Type-B, micro-USB A or B, a USB C charger or any other power provision means.

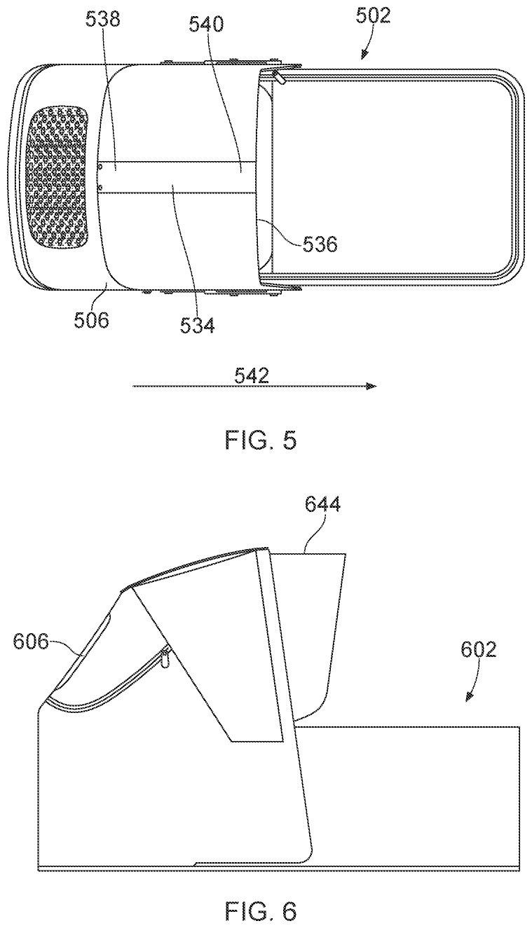

FIG. 5 shows a top view of an example embodiment of an infant enclosure 500.

The infant enclosure 500 includes a handle 534 that is holdable by a person to lift and carry the infant enclosure 502. The handle 534 enables the person to hold the infant enclosure 502 at a location that corresponds to a longitudinal centre of mass of the infant enclosure 502. The longitudinal direction is illustrated in FIG. 5 with arrow 542. This enables the infant enclosure 502 to be well-balanced when it is picked up by a person using the handle 534, without the infant enclosure 502 tipping forwards or backwards.

As shown in FIG. 5, in this example, the handle 534 is connected to the hood 506, and extends in the longitudinal direction 542 of the infant enclosure 502. One end 540 of the handle 534 is connected to an upper front edge region 536 of the hood 506, and the other end 538 of the handle 534 is connected to a position on the hood that is spaced apart from the upper front edge region 536 in the longitudinal direction 532.

As also shown in FIG. 5, the handle 534 can be connected to a laterally central region of the hood 506. This can assist with balancing the infant enclosure 502 in a lateral dimension when it is being held by the handle 534.

FIG. 6 shows a side view of an example embodiment of an infant enclosure 602. In this example, the hood 606 includes a retractable visor 644. When the visor 644 is in an extended position, as shown in FIG. 6, it extends the reach of the hood 606 such that the mesh is set back from the front of the visor and potentially increases the amount of shade for an infant in the infant enclosure 602. When the visor 644 is in a retracted position, as shown in FIG. 1a, sun visor 644 is completely covered by the hood 606. In some examples, the visor may also be configured to reduce the ingress of polluted air into the infant enclosure from the sides and upper edges of the infant enclosure. For example, in normal operation, the fan provides a forward pressure of air through the mesh. Under windy conditions, wind may blow onto the mesh with a greater instantaneous pressure on the mesh than that which is being provided by the fan, thereby resulting in unfiltered air entering the infant enclosure 602. By providing the visor 644, the wind may be prevented from reaching the mesh, thereby reducing the instantaneous pressure by a surprising degree at the mesh and reducing the magnitude of unfiltered air entering the infant enclosure 602 or preventing the unfiltered air penetrating into the infant enclosure 602 altogether.

1. An infant transportation system,. comprising:
an infant enclosure for accommodating an infant;
a filter;
a mesh;
a fan that is configured to pressurise an inside of the infant enclosure such that air is drawn into the infant enclosure through the filter, and air exits the infant enclosure through the mesh;
one or more sensors configured to provide sensed-data that is a measure of one or more environmental parameters associated with the infant transportation system;
a location determining device configured to determine location-data that represents a location associated with the infant transportation system at a time that the sensed-data was provided; and
a transmitter configured to transmit the sensed-data and the associated location-data to a third party device.

2. The infant transportation system of claim 1, wherein:
the filter forms part of a wall of the infant enclosure; and/or
the mesh forms part of a wall of the infant enclosure.

3. The infant transportation system of claim 1 or claim 2, further comprising the third party device, which is configured to:
receive sensed-data and location-data from a plurality of transmitters associated with a respective plurality of infant transportation systems; and
process the sensed-data and the location-data in order to generate a map that graphically illustrates values of the sensed-data at locations on the map that correspond to the associated location-data.

4. The infant transportation system of claim 1, further comprising a mobile communications device, wherein:
the mobile communications device comprises the location determining device and the transmitter;
the one or more sensors are associated with the infant enclosure; and
the mobile communications device is in electronic communication with the one or more sensors such that it is configured to receive the sensed-data from the one or more sensors.

5. The infant transportation system of claim 1, wherein the one or more sensors comprise one or more of:
an air pollution sensor that is configured to provide sensed-external-pollution-data that is representative of a level of air pollution outside of the infant enclosure;
an air pollution sensor that is configured to provide sensed-internal-pollution-data that is representative of a level of air pollution inside the infant enclosure;
a temperature sensor that is configured to provide sensed-internal-temperature-data that is representative of an air temperature inside the infant enclosure;
a humidity sensor that is configured to provide sensed-internal-humidity-data that is representative of a humidity inside the infant enclosure;
a motion sensor that is configured to provide sensed-motion-data that is representative of movement inside the infant enclosure;
a noise-pollution sensor that is configured to provide sensed-sound-data that is representative of sound levels one or both of inside and outside the infant enclosure;
a particle sensor that is configured to provide sensed-external-particle-data that is representative of a level of one or more types of particle outside of the infant enclosure;
a particle sensor that is configured to provide sensed-internal-particle-data that is representative of a level of one or more types of particle inside the infant enclosure; and
a microbe sensor that is configured to provide sensed-microbe-data that is representative of bacteria, viruses or fungi.

6. The infant transportation system of claim 5, wherein the air pollution sensor comprises one or more of an ozone sensor, a particulate matter sensor, a carbon monoxide or carbon dioxide sensor, a sulphur dioxide sensor, and a nitrous oxide sensor, a ground-level ozone sensor, an NOx (nitrogen monoxide and nitrogen dioxide) sensor, a total volatile organic compounds (TVOC) sensor, a peroxyacetyl nitrate sensor, a free radicals sensor.

7. The infant transportation system of claim 1, wherein the fan is a radial fan.

8. The infant transportation system of claim 1, wherein the infant enclosure comprises:
a carrycot having a flat lower surface on which an infant can lie down;
a hood; and
a removable cover that is attachable to the carrycot and the hood, such that the carrycot, the hood and the removable cover define a fully enclosed volume for accommodating the infant;
wherein:
the filter forms part of a wall of the hood; and
the mesh forms part of the removable cover.

9. The infant transportation system of claim 8, wherein:
the removable cover includes the mesh and a solid portion;
when the removable cover is not attached to the carrycot and the hood, an opening is defined through which an infant can be passed to enter or leave the infant enclosure;
the opening has a first portion and a second portion;
the first portion of the opening is defined by: (i) a part of a peripheral edge of the hood that extends beyond a top of the carrycot; and (ii) a line that joins two points at which the hood overlaps the carrycot;
the second portion of the opening is defined by: (i) the line that joins the two points at which the hood overlaps the carrycot; and (ii) an edge of side walls of the carrycot that are distal from the hood;
the removable cover is connectable to the carrycot and the hood such that:
the mesh closes off the first portion of the opening, and
the solid portion closes off the second portion of the opening.

10. The infant transportation system of claim 8 further comprising a filter unit which includes the filter and the fan, wherein the filter unit is attached to the hood.

11. The infant transportation system of claim 1, wherein:
the mesh has a first surface that faces into the infant enclosure, and a second surface that faces away from the infant enclosure; and
the fan and the mesh are located relative to each other such that, across substantially the entire mesh, an air pressure on the first surface of the mesh is greater than an air pressure on the second surface when the fan is in use.

12. The infant transportation system of claim 1, wherein:
the fan is configured to provide an airflow into the infant enclosure; and
the airflow is directed towards the mesh.

13. The infant transportation system of claim 1, wherein the infant enclosure further comprises a handle that is holdable by a person at a location that corresponds to a longitudinal centre of mass of the infant enclosure.

14. The infant transportation system of claim 13, wherein the handle is connected to a hood of the infant transportation system.

15. The infant transportation system of claim 13, wherein the handle extends in a longitudinal direction of the infant enclosure.

16. The infant transportation system of claim 14, wherein the handle is connected to a laterally central region of the hood.

17. The infant transportation system of claim 1, further comprising a display that is configured to provide a graphical representation of the sensed-data.

18. The infant transportation system of claim 1, further comprising a controller configured to:
process the sensed-data and determine a fan-control-signal for automatically setting an adjustable parameter of the fan; and
provide the fan-control-signal to the fan.

19. The infant transportation system of claim 18, wherein the adjustable parameter of the fan is fan speed.
